(19) United States
(12) Patent Application Publication
(10) Pub. No.: US 2023/0241733 A1
(43) Pub. Date: Aug. 3, 2023

(54) TOOL EXCHANGE ASSEMBLY, SET AND CONFIGURATION INCLUDING AT LEAST ONE SUCH TOOL EXCHANGE ASSEMBLY

(71) Applicant: Atlas Copco Tools Central Europe GmbH, Essen (DE)

(72) Inventors: Hermann Foecker, Essen (DE); Jun Zhang, Ingelheim am Rhein (DE)

(73) Assignee: Atlas Copco Tools Central Europe GmbH, Essen (DE)

(21) Appl. No.: 18/092,970

(22) Filed: Jan. 4, 2023

(30) Foreign Application Priority Data
Jan. 28, 2022 (DE) 1020221020487

(51) Int. Cl. B23Q 3/155

(52) U.S. Cl. CPC B23Q 3/1554; B23Q 2003/155449; B23P 19/06

(57) ABSTRACT

The invention relates to a tool exchange assembly configured to swap change tool assemblies, said tool exchange assembly at least comprising a gripper with two opposing rails, said rails extending from a base to an end and forming a cam with increasing width along a path from said end to said base, wherein said cam is configured to be positioned in a gap between outer parts of the tool assemblies being relatively movable with regard to each other, and wherein at least one detector is provided to separately determine whether a tool assembly and a tool manipulator is present at the gripper.

### CROSS-REFERENCE TO RELATED APPLICATION(S)

This application claims priority to German Patent Application No. DE102022102048.7 filed on Jan. 28, 2022, of the same title; the contents of which are hereby incorporated by reference.

### FIELD OF THE INVENTION

The present disclosure relates generally to a tool exchange assembly used to engage a change tool assembly for quickly and efficiently exchanging sockets. The disclosure in particular relates to nutrunners and its tool exchange assembly.

### BACKGROUND OF THE INVENTION

Nutrunners can be used to facilitate the tightening of nuts onto threaded shafts or bolts into threaded ports. Nutrunners are commonly used in an assembly line where it is desirable to drive high quantities of nuts such as during assembly of components. Pneumatic nutrunners are powered by compressed air. Electric nutrunners use a direct current controller as a power supply. Hydraulic nutrunners are powered by hydraulic fluid.

In general, a nutrunner can be used with a change tool assembly that couples the nutrunner with a desired socket. As can be appreciated, sometimes it is necessary to exchange sockets to accommodate different size nuts or bolts.

Existing arrangements used to automatically exchange change tool assemblies and sockets tend to be inefficient and/or complex and/or not fail-safe during (automatic) use.

It would be desirable to provide a system that allows for quick exchange of tool assemblies and for a decreased complexity and/or improved fail-safe characteristics.

### SUMMARY OF THE INVENTION

Proceeding therefrom, it is an object of the present invention to at least alleviate or even solve the issues set forth with reference to the prior art. In particular, a tool exchange assembly with a more robust but even simpler and/or more reliable construction is to be proposed.

In order for said objects to be achieved, a tool exchange assembly according to the features of independent claim 1 is proposed. Advantageous embodiments and related sets and configurations are the subject matter of the dependent claims. The features set forth individually in the claims can be combined with one another in a technologically expedient manner and can be enhanced by explanatory features from the description and details from the figures, wherein further variants of embodiment of the invention are provided.

Therefore, a tool exchange assembly being configured to swap change tool assemblies comprises at least one gripper. The gripper is formed with two opposing rails, said rails extending from a base to an end. The rail(s) form a cam with increasing width along a path from said end to said base, wherein said cam is configured to be positioned in a gap between outer parts of the tool assemblies being relatively movable with regard to each other. Furthermore, at least one detector is provided to separately determine whether a tool assembly and a tool manipulator is present at the gripper.

The tool exchange assembly may be configured to swap change specific and/or different tool assemblies comprising at the least one gripper. It is possible that a plurality or even a multiplicity of grippers are provided, e. g. adjacent to each other along a beam, so that a (multiple) tool manipulator like a robot is given the opportunity to swap change numerous different tool assemblies in a specific area of a manufacturing zone and/or simultaneously at a specific time.

The gripper may be formed like a jaw. The gripper may be provided with (only) two rails, said rails extending parallelly with a given distance to each other from a base to an end. Basically, the (stiff or non-movable) rails may be formed identically but mirror-inverted with regard to the center of the gripper. The rails are usually located and oriented horizontally in on common plane. Thus, the rails form an open space therebetween, allowing that a tool assembly can be inserted and at least partially circumferentially supported therein.

Advantageously, each of said rails form itself a cam. The cam may extend in the open space formed between the rails, in particular along the same horizontal plane. The cam may be integrally formed with the rails. Looking at the design of the cam from the end to the base of the rail, an increasing width can be determined. In particular, the cam may comprise a ramp section which may begin close or at the end of the rail wherein the width (orthogonal to the horizontal plane) is continuously increased. Such an increase of width is not required along the whole path from the end to the base of the rails, a third of said path may be sufficient. Outside such a ramp section, width of said cam may be constant.

The cam is configured to be positioned in a gap between outer parts of the tool assemblies being relatively movable with regard to each other. In other words, the tool assemblies to be inserted into the gripper engage with the rails and cams wherein during insertion the cam to the rails cause at least one outer part of the tool assembly to be moved relatively (along and to the extent of the increasing width) to another part of the tool assembly.

As it emerges from above, the gripper can be provided with a very robust and simple design.

To improve fail-safe use, at least one detector is provided. The detector is or the detectors are arranged and/or equipped so as to separately determine presence, exact orientation and/or a given interaction between anyone of tool assembly and tool manipulator. In particular, one or each gripper may be provided with a detector for determining presence of the related tool assembly and another detector for determining presence of a related tool manipulator.

The detector may be a sensor and or a sensor arrangement. The detector may in particular use optical, electromagnetic, haptic means to determine presence of the tool assembly or tool manipulator. If at least two detectors are provided, those may be similar or different concerning the sensing method or sensing arrangement. In particular, measurements and/or signals obtained and/or caused by the detectors may enable a determination of presence (yes/no) of the tool assembly or the tool manipulator separately. It is possible, that the detector includes passive sensing means causing a clearly identifiable interference of the functionality of either the tool assembly or the tool manipulator (in particular an arm of a robot or a nutrunner), so that monitoring the functionality may be used to identify such interference and detect presence of the tool assembly or the tool manipulator at/in the gripper.

With the proposed system, it is possible to reduce complexity of the gripper and the tool assembly but to increase efficiency and fail-safe use.

In one embodiment, only a single gripper is provided for one tool assembly. In particular, it is preferred to provide only one single gripper for one specific tool assembly, e.g. not a plurality of grippers one above another. It however may be possible to arrange several grippers next to each other in a horizontal plane to provide several swap change locations for several tool assemblies.

Two sensors may be provided at (each of) the gripper(s). Each sensor may be configured as a separate detector. The sensors may be arranged with different distance to the respective gripper. In particular, the distance differs in a direction orthogonally to the horizontal plane of the gripper. A first sensor may be positioned at or close to said horizontal plane, one at a distance above, in particular close to or even above the tool assembly when inserted into the gripper. The first sensor (with small distance) may be configured to determine exclusively the tool assembly position and/or presence. The second sensor (with greater distance) may be configured to determine exclusively the tool manipulator position. The two sensor configuration may be advantageous for tool manipulators with increased torque capacity, for example with an applicable maximum greater than 1.000 Nm, in particular 1.000 to 3.000 Nm.

In an embodiment with two sensors, it is preferred to have two similar sensors, which in particular use the same sensing method or principle. It may be advantageous to use two electromagnetic near field sensors or optical sensors or haptic sensors.

The gripper may comprise at least one rotation stopper configured to engage with a recess provided in the gap between outer parts of the tool assemblies. Such a rotation stopper may be used as an alternative for the first sensor described above and/or in combination with a control unit to form a detector. The rotation stopper may be designed like a pin and/or may be biased by a spring to better engage with the recess of the tool assembly. It is possible to detect movement of the rotation stopper so as to determine an engaged situation. In particular, at least one recess may be provided at the circumference of the tool assembly in the area of the gap, formed when the tool assembly is inserted into the gripper. When and/or after the tool assembly is (laterally) inserted by the tool manipulator, the tool manipulator may rotate the tool assembly so that the rotation stopper snaps into one of the recesses and therefore blocks further rotation. This may be determined by the control unit of the tool manipulator (e.g. due to an increasing torque) so that correct presence and/or position of the tool assembly in the gripper is detected. In this embodiment, an additional electronic (first) sensor can be avoided making the system even more simple, robust, and fail-safe.

The rotation stopper configuration may be advantageous for tool manipulators with lower torque capacity, for example with an applicable maximum of less than 10.000 Nm.

Alternatively or additionally to the rotation stopper, a predefined contact (friction) surface may be provided by (e.g. the socket of) the tool assembly. Said contact surface may have a tapered design and/or adapted to receive a corresponding contact (friction) surface of the tool manipulator. Said contact surface of the tool assembly may be located in an inner space of the socket of the tool assembly being accessible from above. When the front end of the tool manipulator is inserted into (the inner space of the socket of) the tool assembly and (simultaneously) rotated, the friction contact induces an increased torque that can be determined by the control unit. Hence, the control unit may detect presence of the tool manipulator (at a predefined position) if the determined torque reaches a predetermined threshold.

A control unit may be provided which is configured to control movement of the tool manipulator and to receive information regarding the tool assembly position at a specific gripper. It is possible that the control unit is assigned to the tool manipulator. It is possible that the control unit is a superior control unit monitoring and/or controlling the tool exchange assembly. Said control unit may comprise means to receive, calculate, transform information, measurements, data from the detector(s) to determine presence of the tool manipulator and/or tool assemblies in the gripper(s). The control unit may be provided with authority and/or warning means, which may enable and/or disable movements/actions of the tool manipulator and/or which may initiate sending warning information to other systems and or users based on the final determination concerning presence of either tool manipulator or tool assembly.

According to another aspect, a set of at least one tool exchange assembly according to the present disclosure and a tool assembly is proposed, wherein the tool assembly is provided with a socket and an outer sleeve. Here, the outer sleeve is movable in an axial direction when being engaged with the gripper.

The tool assembly may be configured as an adapter forming an intermediate assembly for connecting a specific tool with a tool manipulator.

The socket may be configured to receive, align and/or support a specific tool. Said socket may be provided with a standard fitting stub for tools (at the bottom). The socket may comprise a circumferential section with a number of recesses along the circumference being configured to engage with a rotation stopper of the tool exchange assembly. The socket may form a lower base part of the tool assembly. Said socket may be provided with a (internal) fitting connection part for connecting with a tool manipulator (at the top or opposite the fitting stub for tools).

The outer sleeve may be at least partially imposed on the socket and/or at least partially receiving the socket. The outer sleeve may be positioned by biasing means on the socket. The bypassing means may cause the outer sleeve to abut on an outwardly radially extending edge of the socket. The cam of the rails of the gripper may slide and/or abut on said edge and due to its increasing width move the outer sleeve (upwardly) against said biasing means when the tool assembly is inserted (horizontally) into the gripper. The outer sleeve may be provided with a similar outwardly radially extending edge which interacts with said cam during insertion. The gap between the outer sleeve and the socket may be defined or limited by such respective edges of both outer parts of the tool assembly.

Hence, the at least one tool exchange assembly and the tool assembly may be configured to interact with each other in a determined manner. Concerning such configuration, the separate description of the tool exchange assembly and/or tool assembly can be used to further specify the given set.

In an embodiment, the outer sleeve of the tool assembly may be a part of a ball coupling. The ball coupling can be provided activate/deactivate a (fixed) connection between the socket and the tool manipulator. In particular, the outer sleeve may be provided with internal surfaces and/or structures interact with balls included in the tool assembly so as to install or remove a positive locking of the balls with the tool manipulator, e.g. at a ball clearance thereof. Said balls may be supported by the socket and the outer sleeve. Movement of the outer sleeve (along the axial direction) may cause an at least partially radial movement of the balls. In particular, an upward movement of the outer sleeve (caused by the cam of the gripper) may force the balls to move outward and vice versa. Such a ball coupling may be provided as a quick coupling for the tool manipulator.

According to another aspect, a configuration including a tool manipulator and at least one tool exchange assembly according to the present disclosure is proposed.

According to yet another aspect, a configuration including a tool manipulator and at least one set according to the present disclosure is proposed.

To further specify each of said configurations, the disclosure concerning the tool manipulator, the tool exchange assembly and/or the set can be considered.

By way of precaution, it is pointed out that the numerical words used here (“first”, “second”, etc.) serve primarily (only) for distinction between several similar objects, dimensions or processes, that is to say in particular they do not imperatively predefine a dependency and/or sequence of said objects, dimensions or processes. If a dependency and/or sequence is necessary, this will be explicitly stated here, or will emerge in an obvious manner to a person skilled in the art from a study of the design embodiment being specifically described.

The invention and the technical field will be discussed in more detail below by means of the figures. It is pointed out that the invention is not intended to be restricted by the exemplary embodiments shown. In particular, unless explicitly presented otherwise, it is also possible for partial aspects of the specific subject matter of figures to be extracted and/or combined with other general descriptions above. The same reference signs are usually used to denote identical objects, such that, where appropriate, explanations from other figures can be taken into consideration in a supplementary manner. In the figures, in each case schematically:

### BRIEF DESCRIPTION OF THE DRAWINGS

FIG. 1: an embodiment of a tool manipulator and a tool exchange assembly;

FIG. 2: an embodiment of a tool exchange assembly,

FIG. 3: a sectional view of a tool assembly;

FIG. 4: a side view on an embodiment of a gripper; and

FIG. 5: a sectional view on a tool assembly inserted into a gripper.

### DETAILED DESCRIPTION

The configurations shown and explained in connection with the figures base on a horizontally oriented gripper. However, the same applies correspondingly to vertically oriented gripper wherein the skilled person is clear from the description how the relative movements and positions of the other components changes in this case, predominantly in opposite or orthogonal direction.

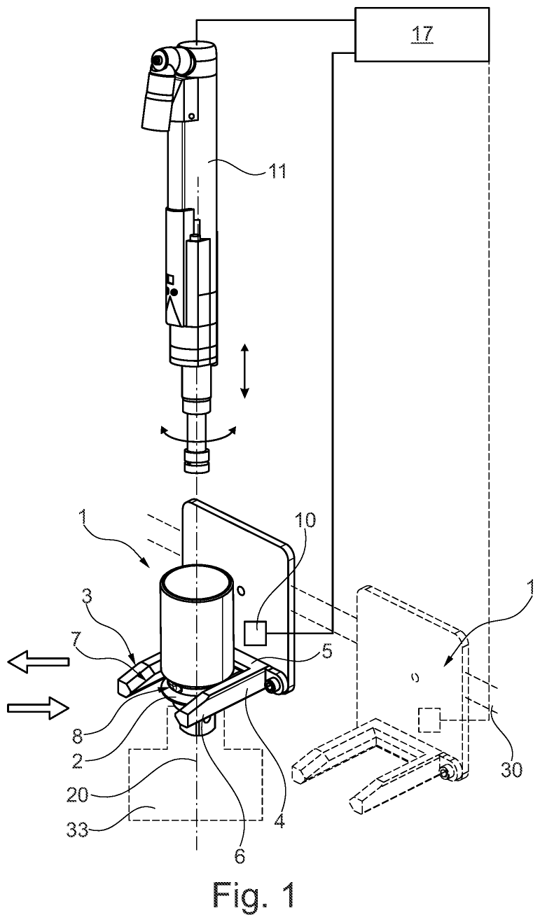

FIG. 1 shows an overview concerning an embodiment of a tool manipulator 11 and a tool exchange assembly 1.

The tool manipulator 11 may be a nutrunner. Operation of the tool manipulator 11 may be controlled by a control unit 17. The tool manipulator 11 may be moved in each direction of the room, in particular (vertically) up and down along the axis 20 (see white double arrow) and orthogonally thereto (within a horizontal plane—see black arrows). The tool manipulator 11 may also be configured to rotate at least partially around the axis 20 (see other white double arrow). The control unit 17 may interact with the tool manipulator 11 and/or the tool exchange assembly 1 by way of a wire and/or wireless connection.

According to the depictured embodiment, a beam 30 is provided where a plurality of tool exchange assemblies 1 are provided adjacent to each other in the same horizontal plane. In the following, the different features of a tool exchange assembly 1 are described wherein each can be realized with one, several or all tool exchange assemblies 1 of such a configuration.

Each tool exchange assembly 1 is configured to swap change one or several tool assemblies 2. Such a tool exchange assembly 1 (respectively) comprises a single gripper 3 having two (horizontally) opposing rails 4. The rails 4 extend (horizontally) from a base 5 to an end 6. Each rail 4 forms a cam 7, wherein both cams 7 are positioned adjacent to each other in a horizontal plane defining an open space therebetween. The cams 7 are designed with width 8 (seen in vertical direction), which increases along a (section of a) path from said end 6 to said base 5.

The cams 7 of each rail 4 are configured to be positioned in a gap 8 between outer parts of the tool assembly 2 to be inserted into the gripper 3. The outer parts of the tool assembly 2 (e.g. an outer sleeve and a socket) are relatively movable with regard to each other. Such movement is caused by direct contact with and/or sliding of the outer parts along the rails 4. As the cams 7 penetrate the gap 8 of the outer parts of the tool assembly 2, the changing width 8 of the cams 7 during this interactive (transversal) movement between tool assembly 2 and gripper 3 causes a widening of the gap 8 during insertion and a closing of the gap 8 during removal.

Furthermore, a detector 10 is provided to separately determine whether a tool assembly 2 and a tool manipulator 11 is present at the gripper 3. In this case, the detector 10 close to the base 5 of the gripper 3 may be configured to (only) determine whether a tool assembly 2 is present (and correctly fixed) at the gripper 3. Another detector may be installed with control unit 17 monitoring the movement and forces resulting with the operation of the tool manipulator 11 so as to finally decide and/or determine whether the tool manipulator 11 is present at the gripper 3 and/or correctly interconnected/positioned with respect to the supported tool assembly 2. Therefore, the detector 10 and the control unit 17 may be interconnected with each other and/or jointly cooperate to constitute a detector (system).

As also shown in FIG. 1, the bottom of the tool assembly 2 may be configured to receive and hold a specific tool 33.

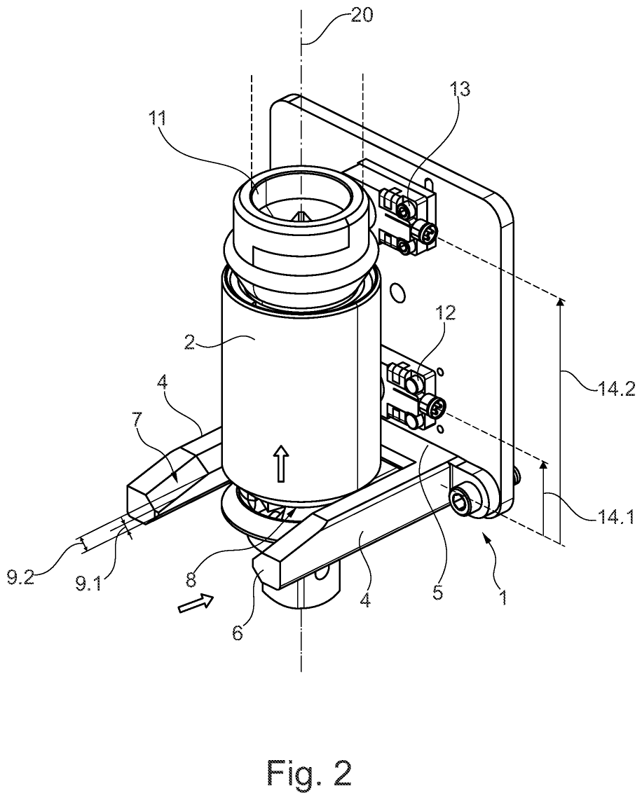

FIG. 2 shows an embodiment of a tool exchange assembly 1 comprising a single gripper 3. Again, two opposing rails 4 are shown which extend from a (common) base 5 to respective tapered ends 6. Laterally, cams 7 of the rails 4 face each other. At the tapered ends 6, sections of the cams 7 are designed with a continuously increasing width 9.1, 9.2 (seen in direction of axis 20). Again, said cams 7 are configured to be positioned in a gap 8 between outer parts of the tool assemblies 2.

In this embodiment, a first sensor 12 and a second sensor 13 are provided at the gripper 3, both being configured to form a detector. The first sensor 12 is provided and installed to determine exclusively presence and position of the tool assembly 2. Therefore, the first sensor 12 is positioned with a (small) first distance 14.1 to the base 5 of the gripper 3. The second sensor 13 is provided and installed to determine exclusively presence and position of the tool manipulator 11. Therefore, the second sensor 13 is positioned with a (larger) second distance 14.2 to the base 5 of the gripper 3. Here, both sensors 12, 13 may be similar, e.g. electromagnetic near field sensors.

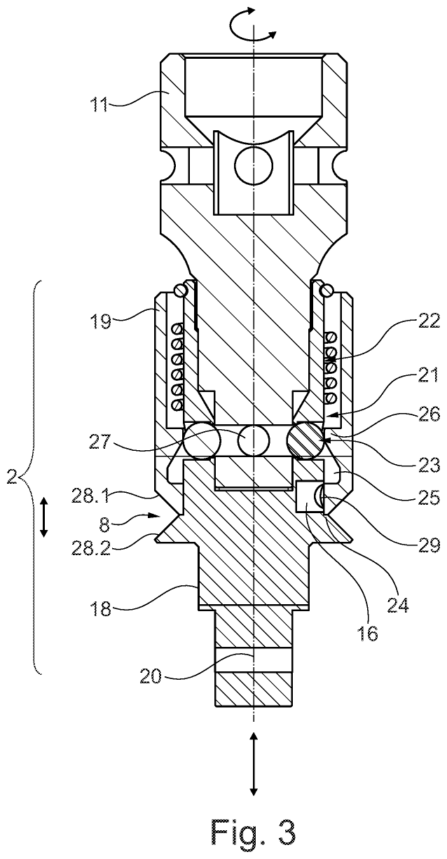

In FIG. 3, a sectional view of a tool assembly 2 is shown wherein a face section of the tool manipulator 11 is securely inserted. The interconnection between the tool manipulator 11 and the tool assembly 2 is realized by a ball coupling 21. In the area of interconnection ball clearances 27 are formed, e.g. four over the entire circumference. Said ball clearances 27 may be designed to receive one or more balls 23, supported internally within the tool assembly 2.

The tool assembly 2 according to the shown embodiment comprises a socket 18 and an outer sleeve 19. The outer sleeve 19 is biased but in direction of the axis 20 movably arranged at the socket 18. In particular, the outer sleeve can be moved (up and/or down) when the tool assembly 2 is laterally engaging or removing the gripper 3.

The socket 18 is designed to receive, align and/or support a specific tool (not depictured) at the lower end section and there formed with a standard fitting stub for tools.

Adjacent and above said lower end section, the socket 18 is provided with a radially outwardly extending edge 24 which may include an inclined (lower) cam or rail contact surface 28.2. Said edge 24 and/or (lower) cam or rail contact surface 28.2 may delimit the gap 8.

Adjacent and above said edge 24, the socket 18 is provided with a (single) recess 16, e.g. in form of a boring. This recess may be configured to receive a positioning element and/or rotation stopper of the tool exchange assembly 1 (not depictured).

Adjacent and above said recess 16, the socket 18 is provided pockets for receiving balls 21.

In an upper section, the socket 18 is be provided with a fitting connection part for being slidingly and precisely aligned with the rotation axis of the tool manipulator (opposite the fitting stub for tools).

The outer sleeve 19 is arranged around the socket 18, in particular above the edge 24 of the socket 18. The outer sleeve 19 is positioned relatively with respect to the socket by biasing means on the socket, here the biasing means are formed like a spring 22. The spring causes the outer sleeve 19 to abut on the (inner area of the) edge 24 of the socket 18.

The (not depictured) cam 7 of the rails 4 can slide and/or abut on said edge 24 of the socket 18 and the lower (inclined) cam or rail contact surface 28.1 of the outer sleeve, when the tool assembly 2 is inserted (horizontally) into the gripper 3 (not depictured). During insertion, the increasing width of the cams 7 induce a movement of the outer sleeve 19 (upwardly) against said spring 22. Thus, the gap 8 between the outer sleeve 19 and the socket 18 is defined and limited by such respective edges 24 of both outer parts of the tool assembly 2.

Here, the outer sleeve 19 of the tool assembly 2 forms a part of a ball coupling 21. The outer sleeve 19 has internal surfaces and/or structures which interact with balls 23 included in the tool assembly 2 so as to install or remove a positive locking of the balls 22 with the tool manipulator 11, e.g. at its ball clearances 27. The balls 23 are supported by or in pockets of the socket 18 and abut on an inwardly extending projection of the outer sleeve 19. Movement of the outer sleeve 19 (along the axial direction) causes positioning of a niche 25 opposite the balls 23 which enables a radial movement of the balls 23. In particular, an upward movement of the outer sleeve 19 (caused by the cam 7 of the gripper 3) forces all balls 23 to move outward. As this occurs during insertion of the tool assembly 2, the internal space is not blocked by the balls 23 which allows the tool manipulator 11 to be inserted into said the internal space. When removing the tool assembly 2 from the gripper 3, the balls 23 move radially inwards to engage with the ball clearances 27 and thus form a quick lock with the tool manipulator 11.

A recess 16 is formed in the outer surface socket 18 in the area of the gap 8. Said recess 16 is covered by (a cap 29 of) the outer sleeve 19 when the gap 8 is minimal. When and/or after the tool assembly 2 is (laterally) inserted by the tool manipulator 11 and the gap 8 is widened by the gripper 3, the tool manipulator 11 may rotate the tool assembly 2 so that a (not depictured) rotation stopper 15 snaps into said recess 16 and therefore blocks further rotation.

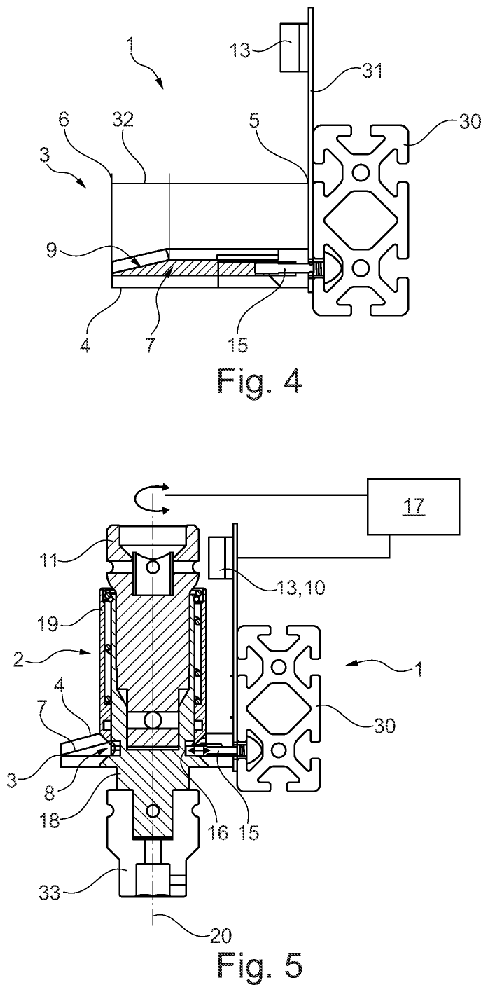

FIG. 4 depictures a side view on an embodiment of a gripper 3 of a tool assembly 1. The tool assembly 1 is fixed to a beam 30 and includes a plate 31. On the plate, a second sensor 13 is provided above the gripper 3, which is configured to determine the presence of a tool manipulator 11 (not depictured here). At the lower area, the horizontal gripper 3 with its rails 4 is positioned. The rails 4 extend from a base 5 at the plate 31 to a distal end 6. The rails include a cam 7. Looking from the end 6 towards the base 5 and in a ramp section 32, the cam 7 is formed with a continuously increasing width 9 perpendicular to the direction of extension of said rails 4. Following this ramp section 32, width 9 of the cam 7 running to the base 5 is constant.

In a plane including the rails 4 of the gripper 3, a rotation stopper 15 is provided, which is configured to engage with a recess 16 provided in the gap 8 between outer parts of the tool assemblies 2 (not depictured here). The rotation stopper 15 is mounted to the base 5 of the gripper 3 and extends in an open space between the rails 4. The rotation stopper 5 is provided as a biased pin being able to move against the biasing spring horizontally.

FIG. 5 shows a sectional view of a tool assembly 2 (similar to the one shown in FIG. 3) inserted into a gripper 3 as shown in FIG. 4. In the correctly inserted position, the outer sleeve 19 of the tool assembly 2 is moved upwards due to a contact with the rails 4/cams 7 so that an increased gap 8 is formed with the tool assembly 2. The tool manipulator 11 is connected to the socket 18 of the tool assembly 2 and able to rotate the tool assembly 2. By rotating the tool assembly 2, the rotation stopper 15 snaps into the recess 16 so as to block further rotation. This causes an increased torque allowing the control unit 17 of the tool manipulator to detect the final and correct position of the tool assembly 2 in the gripper 3. Thus, rotation stopper 15 and control unit 17 form a detector 10 to separately determine whether the tool assembly 2 is present at the gripper 3. The correct position of the tool manipulator 11 can separately determined by the upper second sensor 13. As both, tool assembly 2 and tool manipulator 11 are in the correct position, the control unit 17 may enable the tool manipulator 11 to remove the tool assembly 2 with the attached tool 33 laterally or horizontally from the gripper 3 and to start the desired operation, in particular an automated tightening application in industrial production.

Thus, the present invention solves at least some of the problems of the prior art. In particular, a tool exchange assembly with a more robust and/or simpler and/or more reliable construction is proposed. The system of the present disclosure allows a quick exchange of tool assemblies with decreased complexity and/or improved fail-safe characteristics.

With the given system, a manufacturing cell is enabled to tighten different kinds of screws/bolts with the same tool manipulator. In particular, it is enabled to switch between multiple sockets in a fully automated process without the involvement of an operator. Furthermore, flexibility of the use of a tool manipulator as well as its productivity can be increased. The tool exchange assembly can be provided in a very compact form and allows a full automation of stations where different sockets/bits are required.

### REFERENCE SIGNS

1 tool exchange assembly
2 tool assembly
3 gripper
4 rail
5 base
6 end
7 cam
8 gap
9 width
10 detector
11 tool manipulator
12 first sensor
13 second sensor
14 distance
15 rotation stopper
16 recess
17 control unit
18 socket
19 outer sleeve
20 axial direction/axis
21 ball coupling
22 spring
23 balls
24 edge
25 niche
26 projection
27 ball clearance
28 rail contact surface
29 cap
30 beam
31 plate
32 ramp section
33 tool

1. Tool exchange assembly configured to swap change tool assemblies, said tool exchange assembly at least comprising a gripper with two opposing rails, said rails extending from a base to an end and forming a cam with increasing width along a path from said end to said base, wherein said cam is configured to be positioned in a gap between outer parts of the tool assemblies being relatively movable with regard to each other, and wherein at least one detector is provided to separately determine whether a tool assembly and a tool manipulator is present at the gripper.

2. Tool exchange assembly according to claim 1, wherein a single gripper is provided for one tool assembly.

3. Tool exchange assembly according to claim 1, wherein two sensors are provided at the gripper with different distance thereto, a first sensor being configured to determine exclusively the tool assembly position and a second sensor being configured to determine exclusively the tool manipulator position.

4. Tool exchange assembly according to claim 1, wherein the gripper comprises at least one rotation stopper configured to engage with a recess provided in the gap between outer parts of the tool assemblies.

5. Tool exchange assembly according to claim 1, wherein a control unit is provided which is configured to control movement of the tool manipulator and to receive information regarding the tool assembly position at a specific gripper.

6. Set of at least one tool exchange assembly according to claim 1 and a tool assembly being provided with a socket and an outer sleeve, the outer sleeve being movable in an axial direction when being engaged with the gripper.

7. Set according to claim 6, wherein the outer sleeve of the tool assembly is part of a ball coupling.

8. Configuration including a tool manipulator and at least one tool exchange assembly according claim 1.

9. Configuration including a tool manipulator and at least one set according to claim 6.
